(19) United States
(12) Patent Application Publication
(10) Pub. No.: US 2026/0363928 A1
(43) Pub. Date: Nov. 19, 2026

(54) AIR MATTRESS AND AIR BLOWING CONTROL METHOD

(71) Applicant: PARAMOUNT BED CO., LTD., Tokyo (JP)

(72) Inventors: Masakazu HARADA, Tokyo (JP); Makoto TANAKA, Tokyo (JP)

(21) Appl. No.: 19/666,570

(22) Filed: May 4, 2026

(30) Foreign Application Priority Data
May 19, 2025 (JP) 2025-083246

(51) Int. Cl. A61G 7/057; A61G 7/05; A61G 7/065

(52) U.S. Cl. CPC A61G 7/05769; A61G 7/0527; A61G 7/065; A61G 2200/327; A61G 2200/34

(57) ABSTRACT

An air mattress includes: an air cell including a plurality of cells, an air blowing port through which air is blown to the plurality of cells, and a service port to be connected to a positioning cushion that is used by a user, the positioning cushion having any size of at least a first size, a second size, and a third size; an air blowing apparatus configured to send the air to the air blowing port and the service port; and a controller. The controller includes a processor configured to adjust an air volume of the air blowing apparatus.

### FIELD

Embodiments of the present disclosure relate to an air mattress and an air blowing control method.

### BACKGROUND

For example, in air mattresses, in a case where an accessory that uses an individual pump is used, the improvement in the convenience of the accessory, the individual pump, and the like is desired.

### BRIEF DESCRIPTION OF THE DRAWINGS

FIG. 1 is a perspective view illustrating a bed system including an air mattress according to an embodiment.

FIG. 2 is a plan view illustrating the air mattress according to the embodiment.

FIG. 3A is a schematic view of a positioning cushion.

FIG. 3B is a schematic view of the positioning cushion.

FIG. 4 is a schematic view of a branch joint of the air mattress according to the embodiment.

FIG. 5A is a diagram illustrating a change in the internal pressure when the air is blown to the positioning cushion.

FIG. 5B is a diagram illustrating a change in the internal pressure when the air is blown to the positioning cushion.

FIG. 6 is a block diagram of a controller of the air mattress according to the embodiment.

FIG. 7 is a block diagram of the controller of the air mattress according to the embodiment.

FIG. 8 is a flowchart illustrating an air blowing control method according to the embodiment.

FIG. 9 is a flowchart illustrating an air blowing control method according to the embodiment.

FIG. 10 illustrates an internal pressure table, and views of ratios of a load in a supine position and a chair sitting position.

FIG. 11 is a flowchart illustrating an air blowing control method according to the embodiment.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this disclosure, in some embodiments, the terms "component," "system" and the like are intended to refer to, or comprise, a computer-related entity or an entity related to an operational apparatus with one or more specific functionalities, wherein the entity can be either hardware, or a combination of hardware and software in execution.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software stored on a non-transitory electronic memory or firmware that confers at least in part the functionality of the electronic components. While various components have been illustrated as separate components, it will be appreciated that multiple components can be implemented as a single component, or a single component can be implemented as multiple components, without departing from example embodiments. Further, the various embodiments can be implemented as a method, apparatus or article of manufacture using standard programming and/or engineering techniques to produce software, firmware, hardware or any combination thereof to control a computer to implement the disclosed subject matter. The term "article of manufacture" as used herein is intended to encompass a computer-readable (or machine-readable) device or computer-readable (or machine-readable) storage/communications media having a computer program stored thereon. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words "example" and "exemplary" are used herein to mean serving as an instance or illustration. Any embodiment or design described herein as "example" or "exemplary" is not necessarily to be construed as preferred or advantageous over other embodiments or designs. Rather, use of the word example or exemplary is intended to present concepts in a concrete fashion. As used in this application, the term "or" is intended to mean an inclusive "or" rather than an exclusive "or". That is, unless specified otherwise or clear from context, "X employs A or B" is intended to mean any of the natural inclusive permutations. That is, if X employs A; X employs B; or X employs both A and B, then "X employs A or B" is satisfied under any of the foregoing instances. In addition, the articles "a" and "an" as used in this application and the appended claims should generally be construed to mean "one or more" unless specified otherwise or clear from context to be directed to a singular form.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

In general, one aspect of the present application is an air mattress including:
an air cell including
   a plurality of cells,
   an air blowing port through which air is blown to the plurality of cells, and
   a service port to be connected to a positioning cushion that is used by a user, the positioning cushion having any size of at least a first size, a second size, and a third size;
an air blowing apparatus configured to send the air to the air blowing port and the service port; and
a controller, in which
the controller includes a processor configured to adjust an air volume of the air blowing apparatus, and
the processor is configured to execute a first determination as to whether the positioning cushion is connected to the service port,
when the processor has determined that the positioning cushion is connected to the service port in the first determination, cause the air blowing apparatus to send the air by an amount less than an air capacitance of the positioning cushion toward the positioning cushion in a first period,
execute a second determination to estimate the size of the positioning cushion, based on a state of the positioning cushion after the first period, and the estimation is made based on any of a measurement result of an internal pressure in the positioning cushion after a predetermined elapsed time, or a detection result of an elapsed time until the internal pressure reaches a predetermined value,
cause the air blowing apparatus to blow air such that the internal pressure in the positioning cushion reaches a second internal pressure in a second period, based on a result in the second determination, and
when the processor has determined that the positioning cushion is not connected to the service port, stop the air blowing in which the air is blown to the service port by the air blowing apparatus.

An embodiment provides an air mattress and an air blowing control method capable of improving the convenience.

With the embodiment of the disclosure, the air mattress includes an air cell, an air blowing apparatus, and a controller. The air cell includes a plurality of cells, an air blowing port through which air is blown to the plurality of cells, and a service port to be connected to a positioning cushion that is used by a user. The positioning cushion has any size of at least a first size, a second size, and a third size. The air blowing apparatus is configured to send the air to the air blowing port and the service port. The controller includes a processor configured to adjust an air volume of the air blowing apparatus. The processor executes a first determination as to whether the positioning cushion is connected to the service port. When the processor has determined that the positioning cushion is connected to the service port in the first determination, the processor causes the air blowing apparatus to send the air by an amount less than an air capacitance of the positioning cushion toward the positioning cushion in a first period. The processor executes a second determination to estimate the size of the positioning cushion, based on a state of the positioning cushion after the first period. The estimation is made based on any of a measurement result of an internal pressure in the positioning cushion after a predetermined elapsed time, or a detection result of an elapsed time until the internal pressure reaches a predetermined value. The processor causes the air blowing apparatus to blow air such that the internal pressure in the positioning cushion reaches a second internal pressure in a second period, based on a result in the second determination. In the air mattress, when the processor has determined that the positioning cushion is not connected to the service port, the processor stops the air blowing in which the air is blown to the service port by the air blowing apparatus.

With the embodiment of the disclosure, it is possible to provide the air mattress and the air blowing control method capable of improving the convenience.

Hereinafter, an embodiment of the present disclosure will be described with reference to the drawings.

In the present specification, in a case where a user is lying in a supine position on a bed, when the user is viewed from his/her body, a direction in which his/her head is located is referred to as a "head side", a direction in which his/her feet are located is referred to as a "foot side", a direction in which his/her right hand is located is referred to as a "right side", a direction in which his/her left hand is located is referred to as a "left side", a direction in which a floor surface of a room is located is referred to as a "lower side", and a direction in which a ceiling is located is referred to as an "upper side". The right side and the left side are also collectively referred to as a "lateral direction", the head side and the foot side are also collectively referred to as a "longitudinal direction", and the upper side and the lower side are also collectively referred to as an "up-and-down direction".

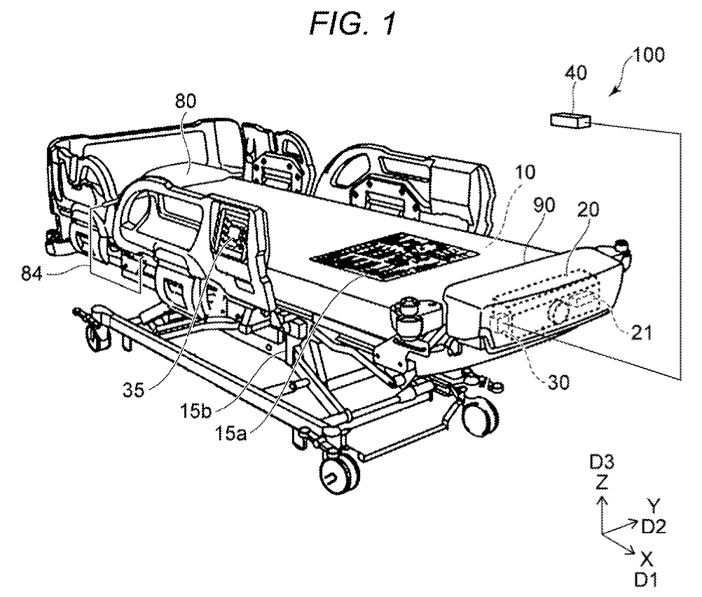

FIG. 1 is a perspective view illustrating a bed system including an air mattress according to an embodiment.

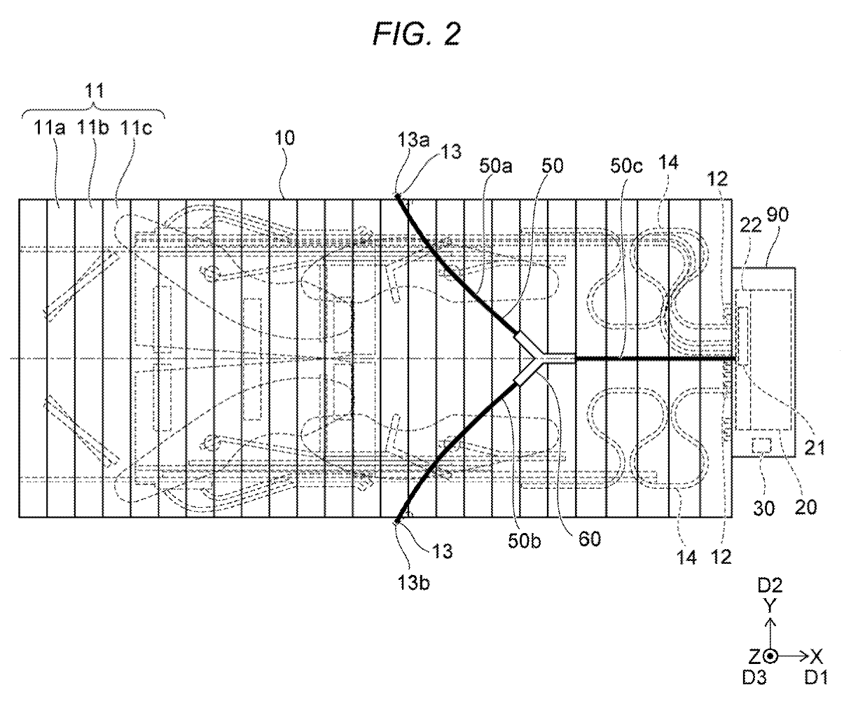

FIG. 2 is a plan view illustrating the air mattress according to the embodiment.

The bed system illustrated in FIG. 1 includes at least a bed, and an air mattress 100 placed to the bed. As illustrated in FIG. 1, the air mattress 100 according to the embodiment includes an air cell 10, an air blowing apparatus 20, a controller 30. The bed is provided with the air mattress 100.

As illustrated in FIG. 2, the air cell 10 includes a plurality of cells 11. The plurality of cells 11 include a plurality of groups each including cells 11a, 11b, and 11c that alternately inflate and deflate. For example, the movement of inflation and deflation with respect to the cells 11a, 11b, and 11c is independently controlled. The embodiment is not limited thereto, but the movement of inflation and deflation with respect to the cells 11a, 11b, and 11c may be controlled so as to move together, for example. The plurality of cells 11 are arranged in a first direction D1. The air sent from the air blowing apparatus 20 is sent to the cells 11a, 11b, and 11c included in each of the plurality of cells 11. The first direction D1 may be an X axis direction, for example. One direction perpendicular to the X axis direction is set as a Y axis direction. A direction perpendicular to the X axis direction and the Y axis direction is set as a Z axis direction. A user of the air mattress 100 lies on the air cell 10.

The air cell 10 includes an air blowing port 12, and a service port 13 to be connected to a positioning cushion 80. The air is blown to the plurality of cells 11 through the air blowing port 12. The air blowing port 12 is connected to the air blowing apparatus 20 via an air cell pipe 14. The service port 13 is a port to be connected to the positioning cushion 80, and a port for the external connection.

As illustrated in FIG. 2, the air mattress 100 may include a tube 50 and a branch joint 60. The air flows into the branch joint 60. The tube 50 is present in a path from the air blowing apparatus 20 to the service port 13. The branch joint 60 is connected to the tube 50, and is present in the path from the air blowing apparatus 20 to the service port 13. The branch joint 60 may be a T-shaped hose joint, for example. The tube 50 includes a first tube 50a, a second tube 50b, and a third tube 50c. The service port 13 includes a first service port 13a and a second service port 13b. The air cell 10 includes the lateral direction, and the longitudinal direction longer than the lateral direction. The first tube 50a is connected to the first service port 13a and the branch joint 60. The second tube 50b is connected to the second service port 13b and the branch joint 60. The third tube 50c is connected to the air blowing apparatus 20 and the branch joint 60. The first service port 13a and the second service port 13b may be provided in the longitudinal direction of the air cell 10. The service port 13 is provided with a valve.

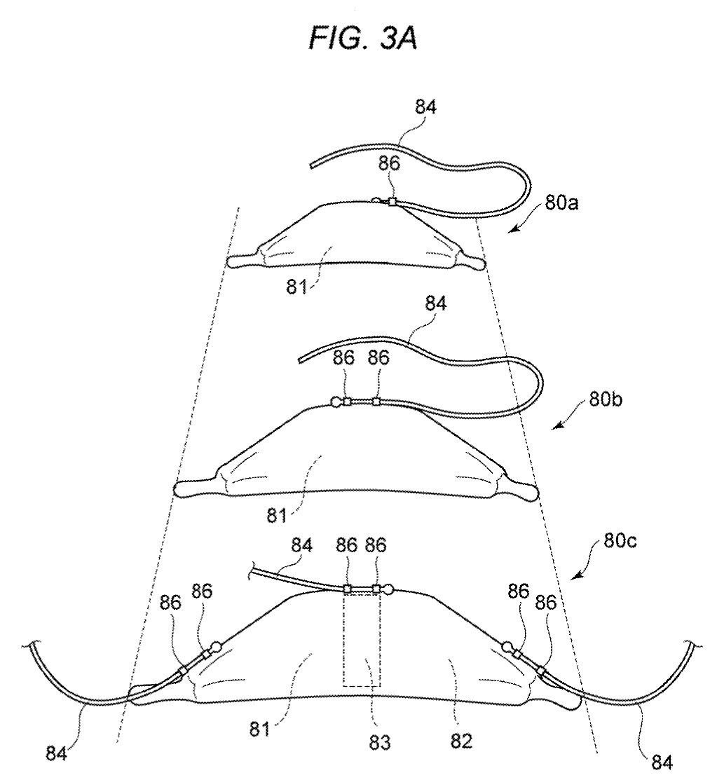

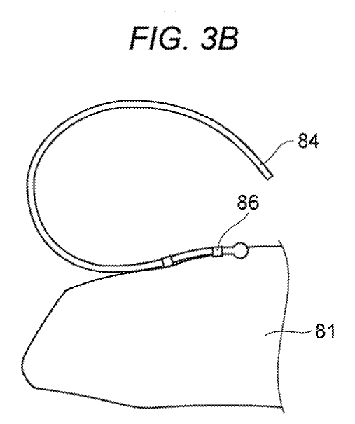

FIGS. 3A and 3B are schematic views of a positioning cushion.

The positioning cushion 80 is a cushion that can inflate when the air is taken, or can deflate when the air is released. As illustrated in FIG. 3A, the positioning cushion 80 has at least a first size, a second size, and a third size. The positioning cushion 80 is a cushion with which the body position is changed as appropriate, for prevention of bedsore, prevention of a contracture, prevention of a pneumonia, and relaxing of a bedridden patient, and positioning is performed so as to make the body stable by inserting the cushion into a gap with the body. The gravity is averagely applied to decrease a distortion of the body and reduce a burden of the user, so that the user can take a comfortable posture. With the positioning cushion 80, a prone position can be held, for example.

The first size is a small size, for example. The second size is an intermediate size, for example. The third size is a large size, for example. FIG. 3A illustrates a positioning cushion 80a of the first size, a positioning cushion 80b of the second size, and a positioning cushion 80c of the third size. The positioning cushion 80 has types of various sizes, in addition thereto. The positioning cushion 80 to which the air is sent from the air blowing apparatus 20 inflates to a predetermined internal pressure.

The air blowing apparatus 20 includes a pressure sensor 21, and a pump 23. The pump 23 sends the air to the air blowing port 12 and the service port 13. The pump 23 sends the air to the plurality of cells 11 and the positioning cushion 80. The pressure sensor 21 may be provided inside a chamber. The pressure sensor 21 measures a pressure in the chamber. The pressure sensor 21 measures the pressure in the chamber, so that the controller 30 makes a first determination, a second determination, and a fourth determination, which are described later. The air blowing apparatus 20 may be disposed at a foot side of the user.

In the positioning cushion 80a of the first size and the positioning cushion 80b of the second size, as illustrated in FIG. 3A, a positioning cushion pipe 84 is provided. In the positioning cushion 80a of the first size and the positioning cushion 80b of the second size, the number of the positioning cushion pipes 84 may be one, for example. The positioning cushion 80a of the first size and the positioning cushion 80b of the second size each include a first space 81. The positioning cushion pipe 84 is connected to the service port 13. The air in the positioning cushion 80 is blown from the air blowing apparatus 20 to the first space 81 via the service port 13 and the positioning cushion pipe 84.

In the positioning cushion 80c of the third size, as illustrated in FIG. 3A, a plurality of the positioning cushion pipes 84 are provided. In the positioning cushion 80c of the third size, the number of the positioning cushion pipes 84 may be three, for example. The positioning cushion 80c of the third size includes the first space 81, a second space 82, and a third space 83. The air from the air blowing apparatus 20 is blown into the first space 81, the second space 82, and the third space 83. The first space 81, the second space 82, and the third space 83 are independent spaces, respectively. The third space 83 is present between the first space 81 and the second space 82. The plurality of positioning cushion pipes 84 are connected to the service port 13. The air in the positioning cushion 80 is blown from the air blowing apparatus 20 to the first space 81 and the second space 82 via the service port 13 and the plurality of positioning cushion pipes 84. The air blowing apparatus 20 may blow the air into the third space 83 via a not-illustrated pipe of the positioning cushion.

The above-described positioning cushion pipes 84 are connected to the positioning cushions 80a to 80c via connectors 86 as illustrated in FIGS. 3A and 3B. The number of the connectors 86 in the positioning cushion 80a of the first size is one, for example. The number of the connectors 86 in the positioning cushion 80b of the second size is two, for example. The number of the connectors 86 in the positioning cushion 80c of the third size is six, for example. The number of the connectors 86 can be changed as appropriate.

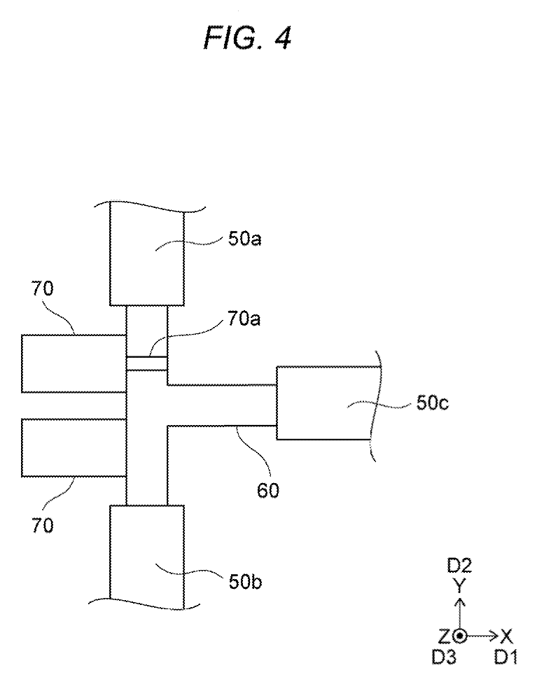

FIG. 4 is a schematic view of a branch joint of the air mattress according to the embodiment.

The air mattress 100 may include a solenoid valve 70 provided to the branch joint 60. The solenoid valve 70 interrupts the flow path with a partition 70a in the branch joint 60 to attain selectable air blowing to the first tube 50a or the second tube 50b.

Among a plurality of configurations of a positioning cushion, the internal pressure when the air is blown to the positioning cushion may be changed in accordance with each configuration. Hereinafter, examples of a plurality of changes will be described.

### First Example

In a first example, the number of the connectors 86 or the number of the positioning cushion pipes 84 is different for each of the plurality of positioning cushions.

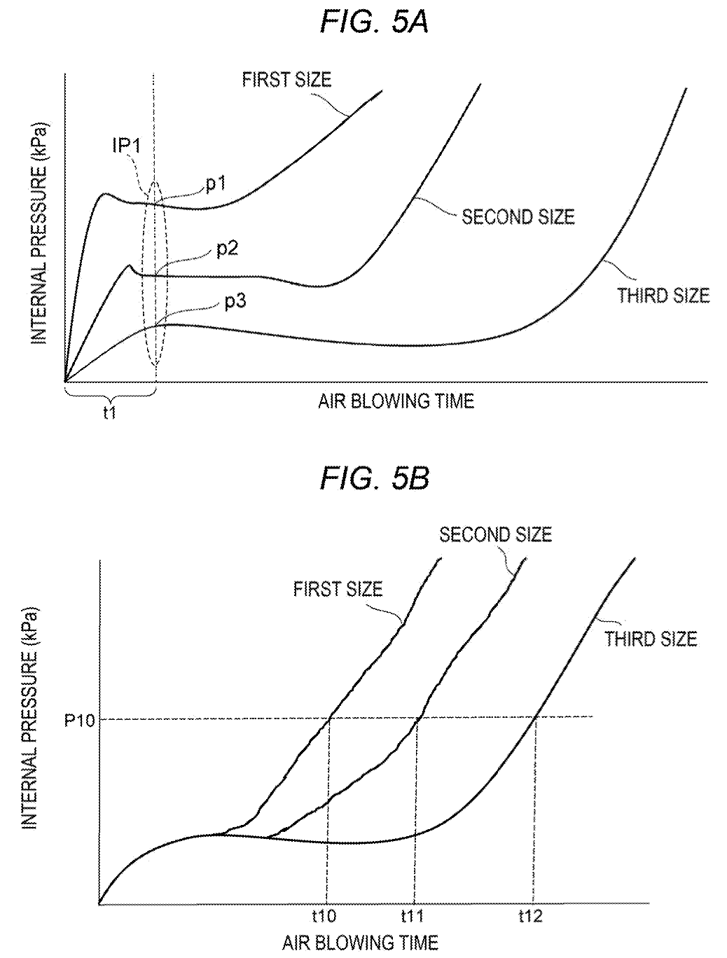

FIG. 5A is a diagram illustrating a change in the internal pressure when the air is blown to the positioning cushion.

FIG. 5A corresponds to the first example. In the example of FIG. 5A, the number of the connectors 86 is one in the positioning cushion 80a of the first size, the number of the connectors 86 is two in the positioning cushion 80b of the second size, and the number of the connectors 86 is six in the positioning cushion 80c of the third size. The number of the connectors 86 is not limited thereto, but the number of the connectors 86 may be nine in the positioning cushion 80c of the third size, for example. The number of the connectors 86 can be designed and changed as appropriate.

The number of the connectors 86 is small in the positioning cushions of the first size and the second size. In the first size and the second size, in a case where the air-supplying amount of air to be blown from the air blowing apparatus 20 exceeds the amount of the air that can be supplied by one connector 86, the surplus air is returned to the air blowing apparatus 20 side. Accordingly, the internal pressure to be detected by the pressure sensor 21 rises relatively quickly. In the positioning cushion of the third size, the number of the connectors 86 is large, so that in a case where the air-supplying amount of air to be blown from the air blowing apparatus 20 does not exceed the amount of the air that can be supplied by the two connectors 86, no surplus air is generated. Accordingly, the air is difficult to return to the air blowing apparatus 20 side, and the internal pressure to be detected by the pressure sensor 21 rises relatively slowly.

When a predetermined period (for example, t1) has elapsed, a difference in the internal pressure in the positioning cushion is generated among the different sizes, based on the air-supplying amount of the pump 23, the capacitance of the positioning cushion, and the air-supplying ability of the positioning cushion pipe 84.

As illustrated in FIG. 5A, the internal pressure in the positioning cushion 80 of the first size rises to a first value p1, the internal pressure in the positioning cushion 80 of the second size rises to a second value p2, and the internal pressure in the positioning cushion 80 of the third size rises to a third value p3. The second value p2 is smaller than the first value p1. The third value p3 is smaller than the second value p2.

In the later-described second determination, after a processor 31, which is described later, has determined that the positioning cushion 80 is connected to a service port, the processor 31 measures an internal pressure after a predetermined period, determines that the positioning cushion of the first size is connected if the internal pressure is equal to or greater than a first threshold, determines that the positioning cushion of the second size is connected if less than the first threshold and equal to or greater than a second threshold (second threshold < first threshold), and determines that the positioning cushion of the third size is connected if less than the second threshold.

### Second Example

In a second example, for example, among a plurality of positioning cushions, the number of the connectors 86 in the positioning cushion is the same.

FIG. 5B is a diagram illustrating a change in the internal pressure when the air is blown to the positioning cushion.

FIG. 5B corresponds to the second example. In the second example, unlike the first example, a change in the internal pressure does not depend on the air-supplying ability of the connector 86. As illustrated in FIG. 5B, when the air is blown to the positioning cushion 80, the internal pressure in the positioning cushion 80 rises. At this time, the internal pressure rises at the different timing for each size of the positioning cushion 80.

Assuming a case where the air blowing apparatus 20 blows the air by a predetermined air blowing amount to the positioning cushion 80 in a predetermined period. In this case, it can be considered that the total air blowing amount of the air to be blown to the positioning cushion 80 in the predetermined period is substantially the same in any of the positioning cushions 80.

However, the size of the positioning cushion 80 connected to the air blowing apparatus 20 differs from the first size to the third size. The elapsed time until the internal pressure reaches a certain internal pressure (for example, an internal pressure P10) differs for each size of the positioning cushion 80.

As illustrated in FIG. 5B, the elapsed time until the internal pressure in the positioning cushion 80 of the first size reaches the predetermined internal pressure P10 is a first period t10. The elapsed time until the internal pressure in the positioning cushion 80 of the second size reaches the predetermined internal pressure P10 is a second period t11. The second period t11 is longer than the first period t10. The elapsed time until the internal pressure in the positioning cushion 80 of the third size reaches the predetermined internal pressure P10 is a third period t12. The third period t12 is longer than the second period t11.

In the later-described second determination, after the later-described processor 31 has determined that the positioning cushion 80 is connected to the service port, the processor 31 detects an internal pressure in the positioning cushion. The processor 31 determines that the positioning cushion of the first size is connected if the time until the internal pressure reaches a predetermined internal pressure is less than a first threshold time. The processor 31 determines that the positioning cushion of the second size is connected if the time until the internal pressure reaches a predetermined internal pressure is equal to or greater than the first threshold time and less than a second threshold time. The processor 31 determines that the positioning cushion of the third size is connected if the time until the internal pressure reaches a predetermined internal pressure is equal to or greater than the second threshold time.

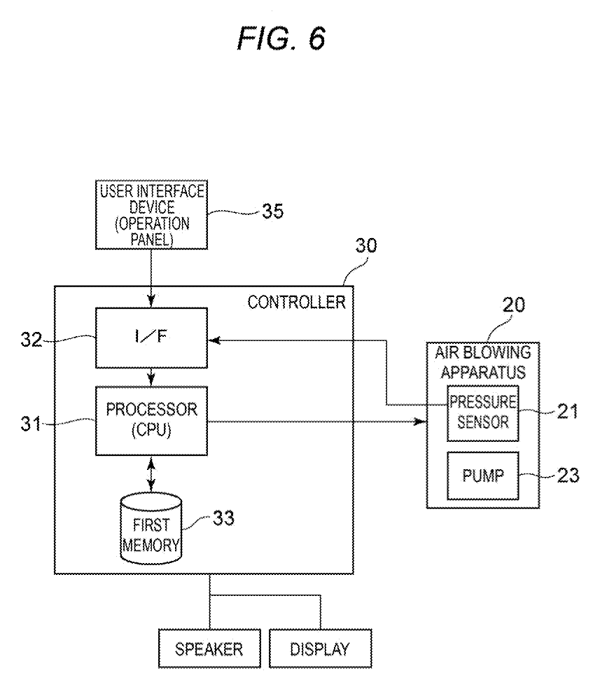

FIG. 6 is a block diagram of a controller of the air mattress according to the embodiment.

As illustrated in FIG. 6, the air mattress 100 includes a user interface device 35, the controller 30, the air blowing apparatus 20, a speaker, and a display. The user interface device 35 may be an operation panel, for example. The user interface device 35 may be provided to a frame of the bed (see FIG. 1). The controller 30 may include an interface 32 (I/F), a first memory 33 (memory) that stores information, and the processor 31 (processor) that operates based on the information stored in the memory. The controller 30 may be a small computer including a communication interface and a processor, for example. The controller may be installed to the air mattress 100. The processor 31 may be implemented by the following processor. The information is a program and various kinds of data, for example. The data includes thresholds (the first threshold, the second threshold) necessary for making the second determination. The data is not limited to a threshold, but may be different data necessary for the determination, for example. For example, the different data is information on a change in the internal pressure as illustrated in FIGS. 5A and 5B. A change in the internal pressure may be expressed by a polynomial, for example. By determining which polynomial data on the acquired internal pressure is similar to, processing in the second determination to determine which size of the positioning cushion is connected may be performed.

The processor includes hardware. As the processors, various kinds of processors including a central processing unit (CPU), a graphics processing unit (GPU), a digital signal processor (DSP), and the like can be used. The memory may be a semiconductor memory such as a static random access memory (SRAM), a dynamic random access memory (DRAM), and a flash memory, may be a register, may be a magnetic storage device such as a hard disk device (HDD: hard disk drive), and may be an optical storage device such as an optical disc device. For example, the memory stores a computer readable command, and the function of the processor 31 is implemented as processing by causing the processor to execute the command. The command mentioned here may be a command of a command set constituting a program or may be a command that gives operation instructions to a hardware circuit of the processor.

The processor 31 adjusts the air volume by the air blowing apparatus 20. An example in which the processor 31 adjusts the air volume by the air blowing apparatus 20 is described later.

The user interface device 35 communicates with the interface 32. The interface 32 communicates with the processor 31. The processor 31 communicates with the first memory 33 and the air blowing apparatus 20. The pressure sensor 21 of the air blowing apparatus 20 communicates with the interface 32. The controller 30 communicates with the speaker and the display.

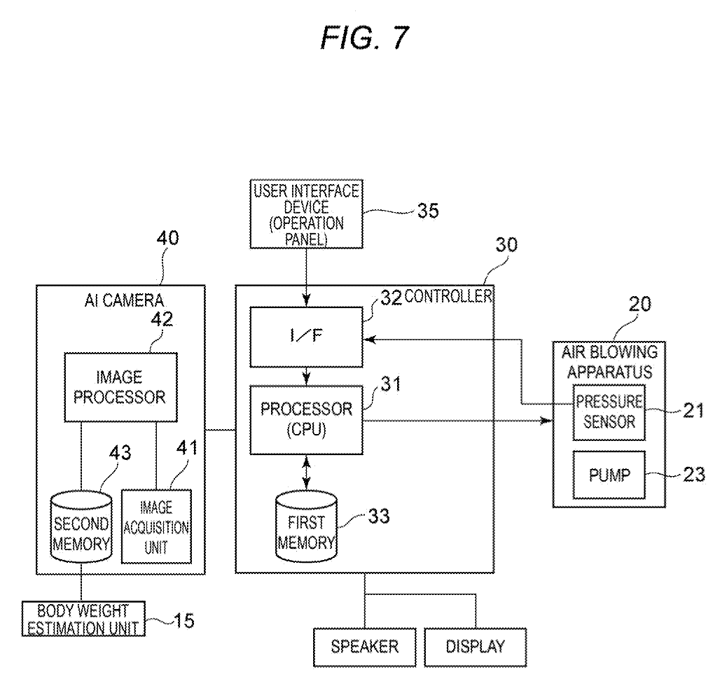

FIG. 7 is a block diagram of a controller of an air mattress according to another embodiment different from that in FIG. 6.

The air mattress 100 illustrated in FIG. 7 may further include an AI camera 40 and a body weight estimation unit 15, in addition to the air mattress in the embodiment in FIG. 6. The technology related to an AI camera is described in JP7514356B, filing date: 19 Apr., 2023, name of invention: SYSTEM, for example. The contents of JP7514356B are incorporated herein as part of the present specification. The AI camera 40 includes an image acquisition unit 41, an image processor 42 that processes information from the image acquisition unit 41, and a second memory 43 (memory) that stores the information processed by the image processor 42. The image acquisition unit 41 acquires an image from the camera. The AI camera may be provided at any position at which a corresponding air mattress and an object on the air mattress can be taken, and for example, the AI camera 40 may be fixed to a frame of the bed to which the air cell 10 is placed. The AI camera 40 may be fixed to a wall surface or the like of the room.

The image processor 42 processes the presence or absence of the connection between the positioning cushion 80 and the service port 13 based on the information from the image acquisition unit 41. The image processor 42 determines which part of a body of a user as an object is placed on the positioning cushion 80 based on the information from the image acquisition unit 41. The body weight estimation unit 15 estimates or measures a body weight of the user. The body weight estimation unit 15 includes a body weight estimation function 15a and a load cell 15b. The body weight estimation function 15a may be provided on the air cell 10. The load cell 15b may be provided below the air cell 10, for example, to the bed (see FIG. 1).

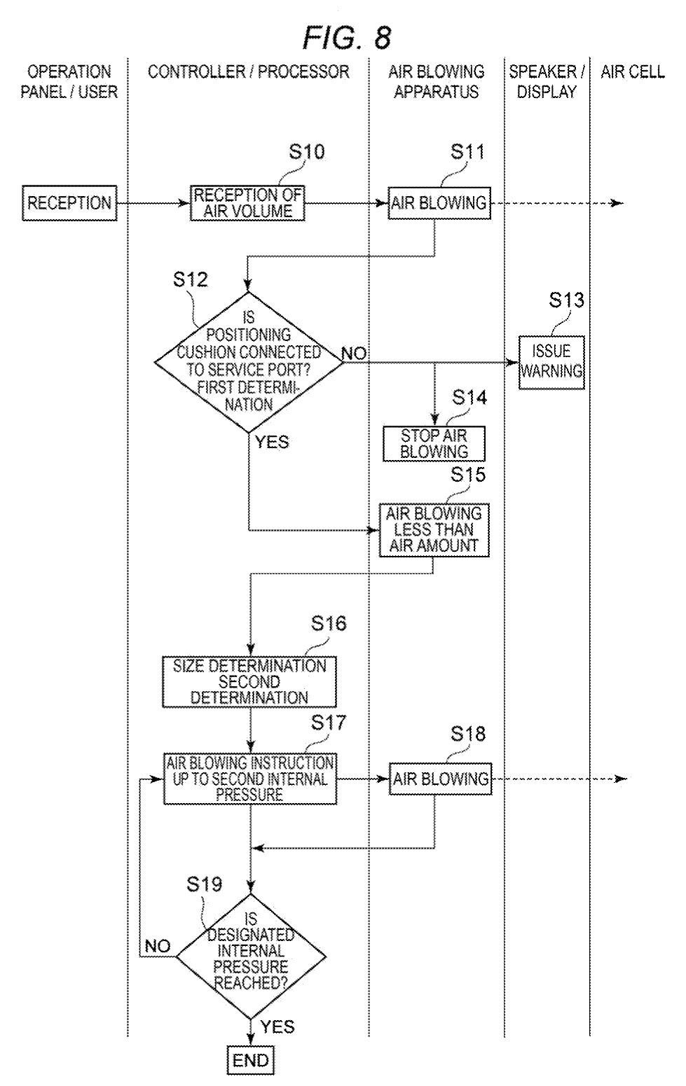

FIG. 8 is a flowchart illustrating an air blowing control method according to the embodiment.

The following corresponds to a case where the configuration of the positioning cushion is the above-described first example. The embodiment may be applied to the second example, for example. The design can be changed as appropriate.

As illustrated in FIG. 8, a user or the like operates the operation panel (the user interface device 35), and the operation panel receives the operation. At this time, buttons "LARGE", "INTERMEDIATE", and, "SMALL" each indicating the air volume of air to be blown to the positioning cushion 80 are displayed on the operation panel. The user presses any of the buttons indicating the air volume and including "LARGE", "INTERMEDIATE", and "SMALL" on the operation panel. After any of the buttons of "LARGE", "INTERMEDIATE", and "SMALL" is pressed, the processor 31 of the controller 30 receives an instruction (for example, information) related to any of the air volumes of "LARGE", "INTERMEDIATE", and "SMALL" (step S10). The air blowing apparatus 20 then receives a command from the controller 30, and blows the air to the positioning cushion 80 (step S11). The information related to the air volumes of "LARGE", "INTERMEDIATE", and "SMALL" is stored in the first memory 33. A second pressure, which is described later and serves as a target, differs depending on which button is pressed.

Next, based on the pressure sensor 21 of the air blowing apparatus 20, the processor 31 of the controller 30 executes a first determination (step S12) as to whether the positioning cushion 80 is connected to the service port 13. For example, when the air is blown to the positioning cushion 80, if the positioning cushion 80 is connected to the service port 13, the valve opens, and the air is blown to the positioning cushion 80. On the other hand, if the positioning cushion 80 is not connected to the service port 13, the valve remains closed, and the internal pressure in the air blowing apparatus 20 rises. The processor 31 determines whether the positioning cushion 80 is connected to the service port 13 accordingly.

If the processor 31 has determined that the positioning cushion 80 is not connected to the service port 13, the processor 31 of the controller 30 may issue a warning with the speaker or the display (step S13). The speaker may emit sound "Please connect the positioning cushion", for example. The display may display "Please connect the positioning cushion", for example, by the processor 31. The processor 31 then stops the air blowing by the air blowing apparatus 20 (step S14).

If the processor 31 has determined that the positioning cushion 80 is connected to the service port 13, the air blowing apparatus 20 receives a command from the processor 31, and blows the air by an air amount less than the air capacitance of the positioning cushion 80, in the first period t1 (step S15). The first period t1 is several seconds, and the time between one second and five seconds, for example.

Next, the processor 31 of the controller 30 executes the second determination based on a first internal pressure IP1 (see FIG. 5) in the positioning cushion 80 to which the air is blown in the first period t1 (step S16). In the second determination, whether the size of the positioning cushion 80 is any of the first size, the second size, and the third size is determined. The second determination is executed in a state where a load of the user is not applied to the positioning cushion 80.

Here, it has already been described that the degree of rise in the internal pressure differs depending on the size of the positioning cushion 80. The number of the positioning cushion pipes 84 and the number of the connectors 86 are different among the first size, the second size, and the third size, so that as illustrated in FIG. 5A, in the first period t1, the degree of rise in the internal pressure in the positioning cushion 80 of the first size as a small size is larger than the degrees of rise in the second size as an intermediate size and the third size as a large size. This is because a resistance occurs when the air is sent to the positioning cushion 80, in a case where the air volume from the air blowing apparatus 20 is determined. For example, the resistance that occurs when the air is sent to the positioning cushion 80a of the first size is larger than that when the air is sent to the positioning cushion 80c of the third size. After the first period t1, when the first internal pressures IP1 in the positioning cushions 80a, 80b, and 80c of the first size, the second size, and the third size are respectively set to the first value p1, the second value p2, and the third value p3, the relation p1 > p2 > p3 is obtained.

In the internal pressure when the air is supplied to the positioning cushion 80 in the first period t1, in a case where no air is present in the positioning cushion 80 from the beginning, the first internal pressure IP1 (the first value p1) in the first size is 0.55±0.05 kPa, for example. The first internal pressure IP1 (the second value p2) in the second size is 0.40±0.05 kPa, for example. The first internal pressure IP1 (the third value p3) in the third size is 0.20±0.05 kPa, for example. The first internal pressure IP1 (the third value p3) in the third size may be the internal pressure in each of the first space 81 and the second space 82 described above.

In the internal pressure when the air is supplied to the positioning cushion 80 in the first period t1, in a case where the air is present in the positioning cushion 80 from the beginning, the first internal pressure IP1 (the first value p1) in the first size is 1.90±0.05 kPa, for example. The first internal pressure IP1 (the second value p2) in the second size is 1.75±0.05 kPa, for example. The first internal pressure IP1 (the third value p3) in the third size is 1.60±0.05 kPa, for example. The first internal pressure IP1 (the third value p3) in the third size may be the internal pressure in each of the first space 81 and the second space 82.

In this manner, the processor executes the second determination to determine whether the size of the positioning cushion 80 is any of the first size, the second size, and the third size, based on the first internal pressure IP1 (the changing amount of the internal pressure) in the positioning cushion 80 to which the air is blown in the first period t1. The processor 31 of the controller 30 executes the second determination based on the changing amount of the first internal pressure IP1. Information related to each of the first value p1, the second value p2, and the third value p3 may be stored in the first memory 33.

Next, the processor 31 of the controller 30 makes an air blowing instruction indicating that the internal pressure is raised to the second internal pressure, to the air blowing apparatus 20 (step S17). The air blowing apparatus 20 then blows the air to the positioning cushion 80 in a second period (step S18). The second period is a period until the internal pressure reaches the second internal pressure. The second internal pressure in the first size may be 1.5±0.3 kPa in a case where the "SMALL" button is pressed, 2.5±0.3 kPa in a case where the "INTERMEDIATE" button is pressed, or 3.5±0.3 kPa in a case where the "LARGE" button is pressed, for example. The internal pressure is measured by the pressure sensor 21. The second internal pressure in the second size and the third size may be similar to the internal pressure in the first size. For example, the second internal pressure may be 2.5±0.3 kPa in a case where the "INTERMEDIATE" button is pressed. The second internal pressure in the third size may be 1.5±0.3 kPa in a case where the "SMALL" button is pressed, for example. The second internal pressure may be a desired internal pressure in a specification situation of the positioning cushion 80.

Next, the processor 31 of the controller 30 determines whether the internal pressure reaches a designated internal pressure (a second internal pressure corresponding to the pressed button) based on the pressure of the pressure sensor 21 (step S19). At this time, the processor 31 makes the determination based on the pressure sensor 21. If the internal pressure does not reach the designated internal pressure, the processor 31 makes an air blowing instruction indicating that the internal pressure is raised to the second internal pressure (step S17). The air blowing apparatus 20 then blows the air to the positioning cushion 80 in a second period (step S18). If the internal pressure has reached the designated internal pressure, the processor 31 stops the air blowing by the air blowing apparatus 20, and ends the processing.

Therefore, with the air mattress 100, the air can be blown to the air cell 10 and the service port 13 by one air blowing apparatus 20. With the air blowing apparatus 20, a separate air pump is unnecessary even in a case where an external accessory is used. A remote controller that separately operates the air pump is unnecessary, and an incorrect operation can be prevented. In a case where a plurality of accessories are used, the incorrect motion caused by a recognition error of the accessory can be prevented. As a result, the convenience of the air mattress 100 is improved. The first determination is made, so that it is possible to stop the air blowing to the service port 13, and prevent a failure of the apparatus. The second determination is made, so that it is possible to attain a suitable internal pressure in the positioning cushion 80. The size of the positioning cushion 80 is distinguished, so that it is possible to accurately control the internal pressure in the positioning cushion 80 without the size recognition of the positioning cushion 80, in the medical and care fields. The motion is efficiently possible without making the detailed settings. No operation difference is generated among persons who perform the operation in the fields. As a result, medical and care service levels can be standardized.

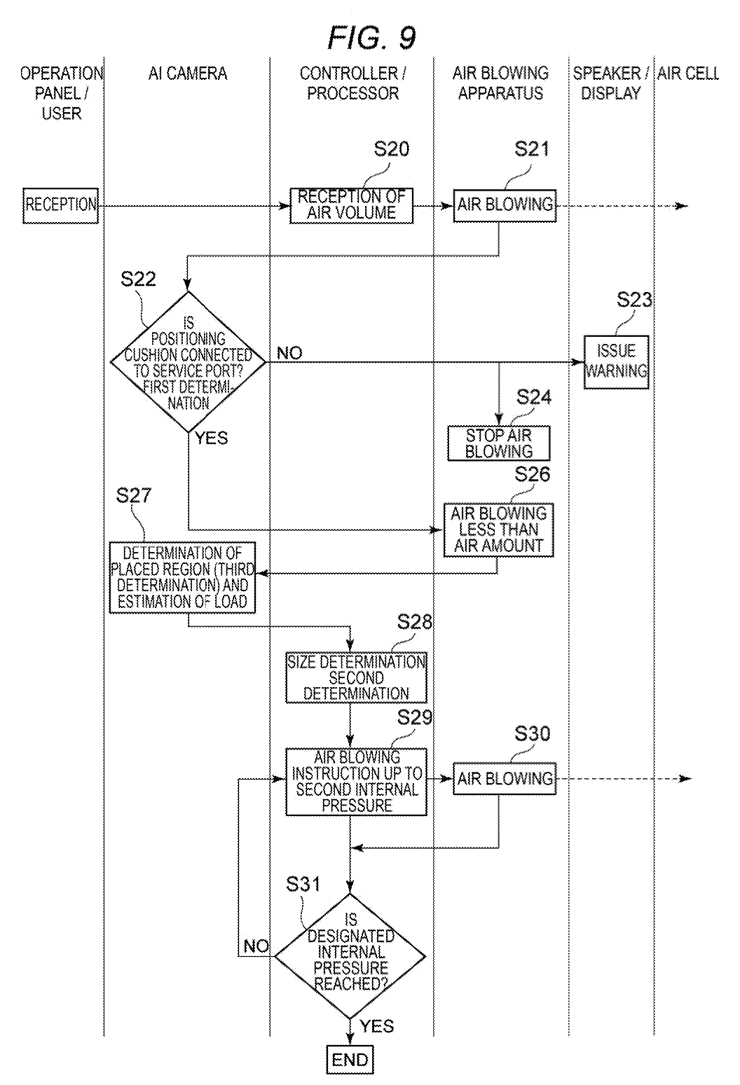

FIG. 9 is a flowchart illustrating an air blowing control method according to the embodiment.

In the air blowing control method illustrated in FIG. 9, the first determination is made by the AI camera 40, instead of the processor 31.

As illustrated in FIG. 9, the operation panel receives an operation. After the button of "LARGE", "INTERMEDIATE", or "SMALL" is pressed, the processor 31 of the controller 30 receives the air volume of "LARGE", "INTERMEDIATE", or "SMALL" (step S20). The air blowing apparatus 20 then receives a command from the controller 30, and blows the air to the positioning cushion 80 (step S21).

Next, the AI camera 40 executes a first determination as to whether the positioning cushion 80 is connected to the service port 13 (step S22). The image acquisition unit 41 acquires a camera image in the first determination. The image processor 42 executes the first determination as to whether the positioning cushion pipe 84 of the positioning cushion 80 is connected to the service port 13, based on the image acquired by the image acquisition unit 41. The second memory 43 stores in advance information related to the recognition of the presence or absence of the connection between the positioning cushion pipe 84 and the service port 13. The image processor 42 executes the first determination based on the information.

If the processor 31 has determined that the positioning cushion 80 is not connected to the service port 13, the processor 31 of the controller 30 may issue a warning (step S23). The warning is as described above. The processor 31 then stops the air blowing by the air blowing apparatus 20 (step S24).

If the processor 31 has determined that the positioning cushion 80 is connected to the service port 13, the air blowing apparatus 20 receives a command from the processor 31, and blows the air by an air amount less than the air capacitance of the positioning cushion 80, in the first period t1 (step S26).

Next, the AI camera 40 makes a third determination to specify a region of the user that is placed on the positioning cushion 80 based on the image acquired by the image acquisition unit 41, and estimation of a load to the positioning cushion 80 (step S27). As for the third determination to specify a region of the user that is placed, for example, the image processor 42 specifies a region such as an arm, a leg, and a seat that is placed on the positioning cushion 80, based on an image acquired by the image acquisition unit 41. For example, the image processor 42 acquires a skeleton of the user from the image, and specifies which skeleton of the user the skeleton included in the area of the positioning cushion 80 is. The second memory 43 stores in advance information with which an arm, a leg, a seat, and the like of the user can be recognized. A load to the positioning cushion 80 may be estimated based on the body weight estimation function 15a or the load cell 15b of the body weight estimation unit 15. The body weight estimation function 15a estimates a body weight of the user from an internal pressure in the air cell 10 when the user lies on the air cell 10. The load cell 15b estimates a body weight of the user from a load when the user lies on the air cell 10. After the body weight estimation unit 15 has estimated the body weight of the user, a load to the positioning cushion 80 is estimated.

The embodiment is not limited thereto, but, for example, after the body weight estimation unit 15 has estimated the body weight of the user (in other words, has detected the situation where the user may come into contact with the air mattress or the positioning cushion), the AI camera 40 is activated, and the image processor 42 may specify a region such as an arm, a leg, and a seat that is placed on the positioning cushion 80 based on the image acquired by the image acquisition unit 41.

Thereafter, the already described step S16, step S17, step S18, and step S19 are conducted.

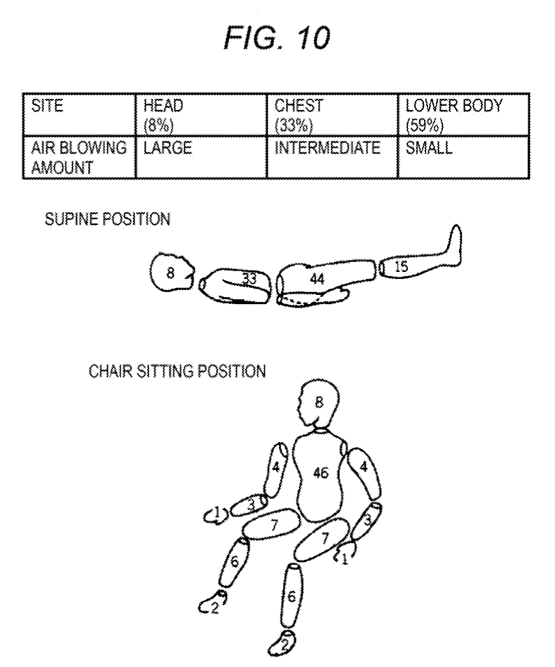

FIG. 10 illustrates an internal pressure table, and views of ratios of a load in a supine position and a chair sitting position.

As illustrated in FIG. 10, in a case where a head of the user is placed on the positioning cushion 80, a load that is 8% of the body weight of the user is applied to the positioning cushion 80. Similarly, in a case where a chest of the user is placed thereon, the load is 3%. Similarly, in a case where a lower body of the user is placed thereon, the load is 59%.

The numbers in the respective regions illustrated in the supine position and the chair sitting position in FIG. 10 each indicate a ratio of the load for each region of the body of the user. In the supine position, for example, in a case where an upper body of the user is placed on the positioning cushion 80, a load that is 33% of the body weight of the user is applied to the positioning cushion 80. In a case of legs, the ratio is 15%. In the chair sitting position, for example, in a case where an upper body of the user is placed on the positioning cushion 80, a load that is 46% of the body weight of the user is applied to the positioning cushion 80. In a case of a thigh, the ratio is 7%. Data on these ratios is stored in the second memory 43. The air blowing amount of the air to be blown from the air blowing apparatus 20 may be adjusted depending on which region is placed on the positioning cushion 80.

As exemplified in FIG. 9, after step S27, the processor 31 of the controller 30 executes the second determination based on the first internal pressure IP1 in the positioning cushion 80 to which the air is blown in the first period t1 (S28). The second determination is executed in a state where a load of the user is applied to the positioning cushion 80. As illustrated in FIG. 10, in a case where a load to be applied to the positioning cushion 80 is small, the air blowing amount of the air blowing apparatus 20 becomes large. In a case where a load to be applied to the positioning cushion 80 is high, the air blowing amount of the air blowing apparatus 20 becomes small. When a body weight of the user is estimated, and which region of the user is placed on the positioning cushion 80 is specified, a load to be applied to the positioning cushion 80 is specified. The processor 31 adjusts the air volume of the air blowing apparatus 20 in accordance with the load. The pressure can be adjusted to a more suitable pressure.

In a case where a body of the user is placed on the positioning cushion 80, the positioning cushion 80 is hidden by the body of the user and cannot be seen in some cases, the second determination may be determined based on the internal pressure, instead of the AI camera 40.

Next, the processor 31 of the controller 30 makes an air blowing instruction indicating that the internal pressure is raised to the second internal pressure, to the air blowing apparatus 20 (step S29). The air blowing apparatus 20 then blows the air to the positioning cushion 80 in the second period (step S30). The second internal pressure is as described above.

Next, the processor 31 of the controller 30 determines whether the internal pressure reaches a designated internal pressure (step S31). If the internal pressure does not reach the designated internal pressure, the processor 31 makes an air blowing instruction indicating that the internal pressure is raised to the second internal pressure (step S29). The air blowing apparatus 20 then blows the air to the positioning cushion 80 in the second period (step S30). If the internal pressure has reached the designated internal pressure, the processor 31 stops the air blowing by the air blowing apparatus 20, and ends the processing.

In the air blowing control method illustrated in FIG. 9, the other methods are similar to those in the air blowing control method illustrated in FIG. 8.

Accordingly, the first determination is made by the AI camera 40, so that the presence or absence of the connection between the service port 13 and the positioning cushion 80 can easily be determined. Even in a case where a region of the user is placed on the positioning cushion 80, the air is supplied by a suitable amount to the positioning cushion 80 to allow the positioning cushion 80 to play a role.

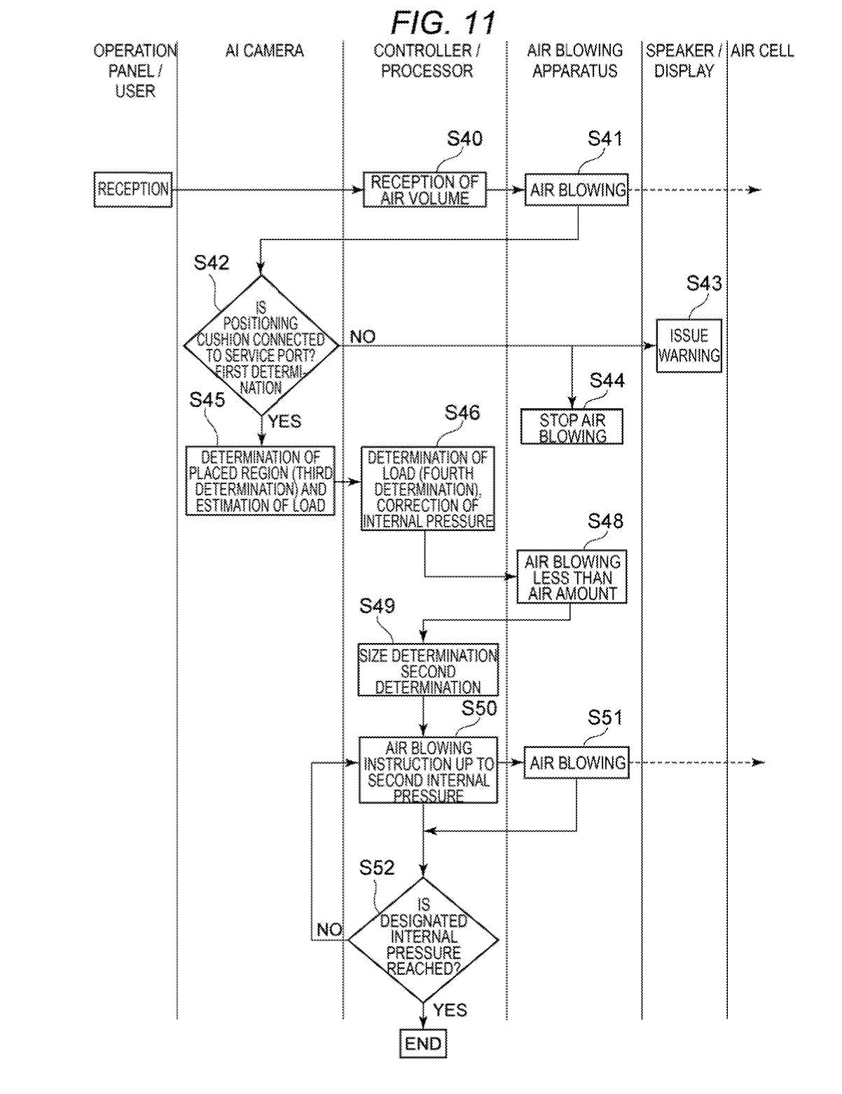

FIG. 11 is a flowchart illustrating an air blowing control method according to the embodiment.

In the air blowing control method illustrated in FIG. 11, the first determination is made by the AI camera 40, instead of the processor 31. After the third determination is made, the internal pressure in the positioning cushion 80 is corrected.

As illustrated in FIG. 11, the operation panel receives an operation. After the button of "LARGE", "INTERMEDIATE", or "SMALL" is pressed, the processor 31 of the controller 30 receives the air volume of "LARGE", "INTERMEDIATE", or "SMALL" (step S40). The air blowing apparatus 20 then receives a command from the controller 30, and blows the air to the positioning cushion 80 (step S41).

Next, the AI camera 40 executes a first determination as to whether the positioning cushion 80 is connected to the service port 13 (step S42). The first determination is the same as the method described in the air blowing control method illustrated in FIG. 9.

If the processor 31 has determined that the positioning cushion 80 is not connected to the service port 13, the processor 31 of the controller 30 may issue a warning (step S43). The warning is as described above. The processor 31 then stops the air blowing by the air blowing apparatus 20 (step S44).

Next, the AI camera 40 makes a third determination to specify a region of the user that is placed on the positioning cushion 80, and estimation of a load to the positioning cushion 80 (step S45). The third determination and the estimation of a load to the positioning cushion 80 are as described above.

The processor 31 corrects the second internal pressure based on the estimated body weight and the third determination (step S46). In this correction, the exemplified second internal pressure in the first size, second internal pressure in the second size, and second internal pressure in the third size are corrected. For example, in a case where the back region of the user is placed on the positioning cushion 80, the processor 31 corrects the internal pressure in the positioning cushion 80 to be high. In a case where the arm region of the user is placed on the positioning cushion 80, the processor 31 corrects the internal pressure in the positioning cushion 80 to be lower than that in a case of the back region. In other words, as for the correction, the second internal pressure in a case where a high load is applied to the positioning cushion 80 is set higher than the second internal pressure in a case where a low load is applied to the positioning cushion 80.

As illustrated in FIG. 11, the air blowing apparatus 20 receives a command from the processor 31, and blows the air by the air amount less than the air capacitance of the positioning cushion 80 in the first period t1 (step S48).

Next, the processor 31 of the controller 30 executes the second determination based on the first internal pressure IP1 in the positioning cushion 80 to which the air is blown in the first period t1 (step S49). The second determination is executed in a state where a load of the user is applied to the positioning cushion 80. The second determination may be determined based on the internal pressure, instead of the AI camera 40.

Next, the processor 31 of the controller 30 makes an air blowing instruction indicating that the internal pressure is raised to the second internal pressure, to the air blowing apparatus 20 (step S50). The air blowing apparatus 20 then blows the air to the positioning cushion 80 in the second period (step S51). The second internal pressure is as described above.

Next, the processor 31 of the controller 30 determines whether the internal pressure reaches a designated internal pressure (step S52). If the internal pressure does not reach the designated internal pressure, the processor 31 makes an air blowing instruction indicating that the internal pressure is raised to the second internal pressure (step S50). The air blowing apparatus 20 then blows the air to the positioning cushion 80 in the second period (step S51). If the internal pressure has reached the designated internal pressure, the processor 31 stops the air blowing by the air blowing apparatus 20, and ends the processing.

In the air blowing control method illustrated in FIG. 11, the other methods are similar to those in the air blowing control method illustrated in FIG. 9.

Accordingly, the processor corrects the second internal pressure based on the fourth determination to make it possible to set the internal pressure in the positioning cushion 80 to a suitable value, decrease a distortion of the body, and reduce a burden of the user, so that the user can take a comfortable posture.

The embodiments may include the following configurations.

### Configuration 1

An air mattress including:
an air cell including
a plurality of cells,
an air blowing port through which air is blown to the plurality of cells, and
a service port to be connected to a positioning cushion that is used by a user, the positioning cushion having any size of at least a first size, a second size, and a third size;
an air blowing apparatus configured to send the air to the air blowing port and the service port; and
a controller, in which
the controller includes a processor configured to adjust an air volume of the air blowing apparatus, and
the processor is configured to
execute a first determination as to whether the positioning cushion is connected to the service port,
when the processor has determined that the positioning cushion is connected to the service port in the first determination, cause the air blowing apparatus to send the air by an amount less than an air capacitance of the positioning cushion toward the positioning cushion in a first period,
execute a second determination to estimate the size of the positioning cushion, based on a state of the positioning cushion after the first period, and the estimation is made based on any of a measurement result of an internal pressure in the positioning cushion after a predetermined elapsed time, or a detection result of an elapsed time until the internal pressure reaches a predetermined value,
cause the air blowing apparatus to blow air such that the internal pressure in the positioning cushion reaches a second internal pressure in a second period, based on a result in the second determination, and
when the processor has determined that the positioning cushion is not connected to the service port, stop the air blowing in which the air is blown to the service port by the air blowing apparatus.

### Configuration 2

The air mattress according to configuration 1, in which
the air blowing apparatus includes a pressure sensor inside, and
the processor is configured to execute the first determination based on a pressure from the pressure sensor.

### Configuration 3

The air mattress according to configuration 1 or 2, in which the processor is configured to execute the second determination based on a changing amount of the first internal pressure.

### Configuration 4

The air mattress according to any one of configurations 1 to 3, in which the second determination is executed in a state where no load of the user is applied to the positioning cushion.

### Configuration 5

The air mattress according to any one of configurations 1 to 3, further including an AI camera including an image acquisition unit, and an image processor that processes an image acquired by the image acquisition unit, in which
the AI camera is configured to execute the first determination based on image recognition by the AI camera, instead of the processor, and
the image recognition is executed by the image acquisition unit and the image processor.

### Configuration 6

The air mattress according to configuration 5, further including a body weight estimation function, in which
the processor is configured to execute a third determination to determine a region of the user that is placed on the positioning cushion based on the image recognition by the AI camera, and
the body weight estimation function is configured to estimate a body weight of the user from an internal pressure in the air cell when the user lies on the air cell.

### Configuration 7

The air mattress according to configuration 6, in which
the processor is configured to execute a fourth determination to determine a load to be applied to the positioning cushion from the estimated body weight and the third determination, and
the processor is configured to correct the second internal pressure based on the fourth determination, and causes the air blowing apparatus to blow air to the positioning cushion.

### Configuration 8

The air mattress according to any one of configurations 5 to 7, in which the second determination is executed in a state where the load of the user is applied to the positioning cushion.

### Configuration 9

The air mattress according to any one of configurations 1 to 8, further including:
a tube that is present in a path from the air blowing apparatus to the service port; and
a branch joint that is connected to the tube, and is present in the path from the air blowing apparatus to the service port, in which
the tube includes a first tube, a second tube, and a third tube,
the service port includes a first service port, and a second service port,
the air cell includes a lateral direction, and a longitudinal direction longer than the lateral direction,
the first service port and the second service port are provided in the longitudinal direction of the air cell, the first tube is connected to the first service port and the branch joint,
the second tube is connected to the second service port and the branch joint, and
the third tube is connected to the air blowing apparatus and the branch joint.

### Configuration 10

The air mattress according to configuration 9, further including a solenoid valve that is provided to the branch joint.

### Configuration 11

An air blowing control method including:
blowing air from an air blowing apparatus to a service port to which a positioning cushion that has at least any size of a first size, a second size, and a third size, and is used by a user is connected;
making a first determination as to whether the positioning cushion is connected to the service port;
causing the air blowing apparatus to blow air by an air amount less than an air capacitance of the positioning cushion in a first period, when it has been determined that the positioning cushion is connected to the service port;
making a second determination as to whether the positioning cushion is any of the first size, the second size, and the third size, based on a first internal pressure in the positioning cushion to which the air is blown in the first period;
causing the air blowing apparatus to blow the air until a second internal pressure is reached in a second period; and
stopping the air to be blown to the service port, when the processor has determined that the positioning cushion is not connected to the service port.

### Configuration 12

The air blowing control method according to configuration 11, in which the first determination is made based on a pressure by a pressure sensor that is provided into the air blowing apparatus.

### Configuration 13

The air blowing control method according to configuration 11 or 12, in which the second determination is made based on a changing amount of the first internal pressure.

### Configuration 14

The air blowing control method according to any one of configurations 11 to 13, further including issuing a warning when the processor has determined that the positioning cushion is not connected to the service port.

### Configuration 15

The air blowing control method according to any one of configurations 11 to 14, in which the second determination is made in a state where no load of the user is applied to the positioning cushion.

### Configuration 16

The air blowing control method according to any one of configurations 11 to 14, in which the first determination is made based on image recognition by an AI camera.

### Configuration 17

The air blowing control method according to configuration 16, further including:
making a third determination to determine a region of the user that is placed on the positioning cushion based on the image recognition by the AI camera; and
estimating, by a body weight estimation function included in an air cell, a body weight of the user from an internal pressure in the air cell when the user lies on the air cell.

### Configuration 18

The air blowing control method according to configuration 17, further including:
making a fourth determination to determine a load to be applied to the positioning cushion based on the estimated body weight and the third determination;
correcting the second internal pressure based on the fourth determination; and
causing the air blowing apparatus to blow air to the positioning cushion.

### Configuration 19

The air blowing control method according to any one of configurations 16 to 18, in which the second determination is made in a state where a load of the user is applied to the positioning cushion.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An air mattress comprising:
an air cell including
a plurality of cells,
an air blowing port configured to inflate or deflate the plurality of cells, and
a service port configured to be capable of connecting to a cushion for a user,
an air blowing apparatus configured to send the air to the air blowing port and the service port; and
a controller configured to adjust an air volume of the air blowing apparatus, and
the controller is configured to:
execute a first determination processing as to whether the cushion is connected to the service port,
cause the air blowing apparatus to supply the air by a first amount toward the cushion in a first period if the controller has determined that the cushion is connected to the service port in the first determination,
execute a second determination processing to estimate the size of the cushion, based on a state of the cushion after the first period, and the state of the cushion includes a measurement result of an internal pressure in the cushion after a predetermined elapsed time, or a detection result of an elapsed time until the internal pressure reaches a predetermined value.

2. The air mattress according to claim 1, wherein the controller is configured to:
cause the air blowing apparatus to supply air such that the internal pressure in the cushion reaches a second internal pressure in a second period after the first period, based on a result in the second determination.

3. The air mattress according to claim 2, wherein the controller is configured to:
stop supplying air to the service port by the air blowing apparatus if the controller has determined that the cushion is not connected to the service port.

4. The air mattress according to claim 1, wherein
the air blowing apparatus includes a pressure sensor, and
the controller is configured to execute the first determination based on a pressure from the pressure sensor.

5. The air mattress according to claim 1, wherein the controller is configured to execute the second determination based on a changing amount of the first internal pressure.

6. The air mattress according to claim 1, wherein the controller is configured to execute the second determination in a state where no load of the user is applied to the cushion.

7. The air mattress according to claim 1, further comprising a camera including an image acquiring unit, and an image processor that processes an image acquired by the image acquiring unit, wherein
the camera is configured to execute the first determination based on image recognition by the camera, instead of the processor, and
the image recognition is executed by the image acquiring unit and the image processor.

8. The air mattress according to claim 7, further comprising a body weight estimator, wherein
the controller is configured to execute a third determination processing to determine a region of the user that is placed on the cushion based on the image recognition by the camera, and
the body weight estimator is configured to estimate a body weight of the user from an internal pressure in the air cell if the user lies on the air cell.

9. The air mattress according to claim 8, wherein
the controller is configured to execute a fourth determination processing to determine a load to be applied to the cushion from the estimated body weight and the determined region of the user from the third determination processing, and
the controller is configured to correct the second internal pressure based on a result of the fourth determination processing, and causes the air blowing apparatus to supply air to the cushion.

10. The air mattress according to claim 9, further comprising:
a tube configured to connect the air blowing apparatus to the service port; and
a branch joint configured to connect to the tube, and provided between the air blowing apparatus and the service port, in which
the tube includes a first tube, a second tube, and a third tube,
the service port includes a first service port, and a second service port,
the first service port and the second service port are provided in the longitudinal direction of the air cell,
the first tube is configured to connect to the first service port and the branch joint,
the second tube is configured to connect to the second service port and the branch joint, and
the third tube is configured connect to the air blowing apparatus and the branch joint.

11. A method for controlling an air mattress, the air mattress including an air cell having a plurality of cells, an air blowing port, and a service port configured to be connectable to a cushion; an air blowing apparatus; and a controller, the method comprising:
executing, by the controller, a first determination processing as to whether the cushion is connected to the service port;
causing, by the controller, the air blowing apparatus to supply air by a first amount toward the cushion in a first period if it is determined in the first determination processing that the cushion is connected to the service port; and
executing, by the controller, a second determination processing to estimate a size of the cushion based on a state of the cushion after the first period,
wherein the state of the cushion includes a measurement result of an internal pressure in the cushion after a predetermined elapsed time, or a detection result of an elapsed time until the internal pressure reaches a predetermined value.

12. The method according to claim 11, further comprising:
causing, by the controller, the air blowing apparatus to supply air such that the internal pressure in the cushion reaches a second internal pressure in a second period after the first period, based on a result of the second determination processing.

13. The method according to claim 12, further comprising:
stopping the supply of air to the service port by the air blowing apparatus if it is determined in the first determination processing that the cushion is not connected to the service port.

14. The method according to claim 11, wherein
the air blowing apparatus includes a pressure sensor, and
the first determination processing is executed based on a pressure detected by the pressure sensor.

15. The method according to claim 11, wherein the second determination processing is executed based on a changing amount of the internal pressure.

16. The method according to claim 11, wherein the second determination processing is executed in a state where no load of a user is applied to the cushion.

17. The method according to claim 11, wherein the air mattress further comprises a camera including an image acquiring unit and an image processor, the method further comprising:
executing the first determination processing based on image recognition by the camera.

18. The method according to claim 17, wherein the air mattress further comprises a body weight estimator, the method further comprising:
executing, by the controller, a third determination processing to determine a region of a user that is placed on the cushion based on the image recognition by the camera; and
estimating, by the body weight estimator, a body weight of the user from an internal pressure in the air cell when the user lies on the air cell.

19. The method according to claim 18, further comprising:
executing, by the controller, a fourth determination processing to determine a load to be applied to the cushion from the estimated body weight and the determined region of the user;
correcting the second internal pressure based on a result of the fourth determination processing; and
causing the air blowing apparatus to supply air to the cushion based on the corrected second internal pressure.
